(19) United States
(12) Patent Application Publication
(10) Pub. No.: US 2018/0082805 A1
(43) Pub. Date: Mar. 22, 2018

(54) ELECTRIC SWITCH

(71) Applicant: Johnson Electric S.A., Murten (CH)

(72) Inventor: Gerhard FANGMANN, Marienheide (DE)

(21) Appl. No.: 15/711,661

(22) Filed: Sep. 21, 2017

(30) Foreign Application Priority Data
Sep. 21, 2016 (DE) 102016117783.0

(51) Int. Cl. H01H 15/10; H01H 15/04

(52) U.S. Cl. CPC H01H 15/10; H01H 15/04; H01H 2235/01; H01H 2223/04; H01H 2205/002; H01H 2231/048

(57) ABSTRACT

An electric switch used in an electric device having a motor is provided. The electric switch comprises a switch housing, a plunger extending from the switch housing and switching from an off position into an on position of at least one contact of a contact system arranged within the switch housing via a movement, a circuit board; and a changeover device for changing a direction of rotation of the motor. The changeover device comprises a position encoder operated from outside, the position encoder is directly connected to a contact arm via two contact tongues; one contact tongue interacts with one conducting path to create a contact for the clockwise rotation of the motor in one position of the position encoder, and/or the other contact tongue interacts with other conducting paths to create a contact for the counterclockwise rotation of the motor in another position of the position encoder.

### CROSS REFERENCE TO RELATED APPLICATIONS

This non-provisional patent application claims priority under 35 U.S.C. § 119(a) from Patent Application No. 10 2016 117 783.0 filed in Germany on Sep. 21, 2016.

### TECHNICAL FIELD

The present disclosure relates to an electric switch, in particular a switch for manually operated electric hand tools having a motor.

### BACKGROUND

In general, electric switches of this type for manually operated electric tools and appliances, such as electric drills, cordless screwdrivers, hammer drills or the like include a changeover device for shifting the direction of rotation of the motor in addition to the electric circuit, which can be switched by an actuation element able to be activated from outside. Control and regulation of rotational speed or torque can be provided in addition to this changeover device. One advantageous electric switch is known from the German document DE 10 2014 112 982 A1 (trigger switch). This well-known electric switch is provided with a changeover device for changing the direction of rotation of the motor, meaning from clockwise to counterclockwise or vice versa. First, corresponding conducting paths are provided on the circuit board for this purpose. Second, the changeover device includes a position encoder able to be operated from the outside by means of rotational movement of the adjustable position encoder, which is connected to a shift lever inside the switch housing. Rotary actuation of the position encoder causes contact tongues arranged on the shift lever to connect either with the conducting paths on the circuit board for clockwise rotation or with the conducting paths on the circuit board for counterclockwise rotation of the motor.

### SUMMARY

The novel electric switch is particularly for use in manually operated electric tools having a motor. This electric switch includes a switch housing. Protruding from this housing is a plunger, which is connected to an actuation element and is used for manually operating the electric device. Actuation of the actuation element causes the plunger to move, namely from an initial position, where the electric device is switched off, to an on position, where the electric device is switched on, because movement of the plunger causes switching of at least one contact of a contact system arranged within the switch housing. A circuit board is arranged within the switch housing.

This electric switch furthermore includes a changeover device for changing the direction of rotation. This changeover device comprises a position encoder able to be operated from outside. According to the invention, the position encoder is connected to a contact arm whereupon two contact tongues are arranged, whereby the contact tongues interact with conducting paths for clockwise rotation of the motor when the position encoder is in one position, or they interact with conducting paths for counterclockwise rotation of the motor when the position encoder is in another position. Consequently, in this embodiment of the invention the position encoder is connected directly to the contact tongues, which act on the conducting paths on the circuit board. As a result, the changeover device is considerably simplified in contrast to the known design, which additionally uses a shift lever. Being a part of the contact arm, these contact tongues are directly connected to the movable position encoder in order to change the direction of rotation of the motor from clockwise to counterclockwise. Variously contact conducting paths on the circuit board contact the contact tongues.

To set clockwise or counterclockwise rotation of the motor, the position encoder is actuated from the outside either directly or via an actuator that is accessible from the outside. This setting can be made by way of a linear pushing movement of the actuator or by a rotary movement.

In a preferential embodiment, the contact system is configured for actuating the switch and switching the electric device on and off is provided on one face of the circuit board, for example on an upper face of the circuit board. The conducting paths of the changeover device, which interact with the contact tongues of the position encoder, are arranged on a lower face of the circuit board. Thus, a very compact design is achieved.

In an embodiment of the invention, the position encoder is retained in an enclosure in the housing and is in the form of a disk. Rotary actuation of the disk of the position encoder transmits torque to the contact arm, which is provided on the inside of the switch housing and is retained on the position encoder. The disk of the position encoder is rotatably retained in the enclosure of the switch housing and rotates in a plane oriented parallel to the circuit board. Depending on the rotational position of the disk, the contact tongues formed on the end of the contact arm are either connected to the conducting path on the circuit board for clockwise rotation of the motor, or the contact tongues create a contact bridge for conducting paths for counterclockwise rotation of the motor.

In an embodiment, a tappet is provided on the outer side of the position encoder for movement, in particular for rotary actuation. This tappet interacts, for example, with a rotary directional switch on the hand operated electric tool. The contact arm is provided on the inner side of the position encoder. If the position encoder comprises a disk, then the contact arm is connected to the inner side of the disk so that rotary actuation of the disk of the position encoder also causes the contact arm to move. In order to mount the contact arm, the disk includes a mounting enclosure slit in an inner side and off of a center of the disk. The contact arm is inserted into this slit and retained by a form fit or an interference fit. Due to the off-center arrangement of the contact arm on the disk, rotary movement of the disk changes the position of the contact arm, thus changing the position of the contact tongues of the contact arm, which contact conducting paths on the circuit board.

In a preferential embodiment, the position encoder also comprises a haptic element, which interacts with a peripheral contour of the enclosure in the switch housing, namely the enclosure that rotatably retains the position encoder. The various positions of the contact arm for clockwise or counterclockwise rotation of the motor are provided as corresponding engagement positions in the peripheral contour of the enclosure in the switch housing.

The electric switch described above is built to be quite compact. The changeover device is considerably simplified in contrast to the known design because no additional lever is necessary for transmitting the rotational movement of the position encoder to the contact tongues. The design height of the switch can thus be reduced accordingly.

### BRIEF DESCRIPTION OF THE DRAWINGS

FIG. 1 is a perspective view of an electric switch according to one embodiment.

FIG. 2 is a perspective view of the electric switch of FIG. 1 from below.

FIG. 3 is a perspective view of a position encoder of FIG. 1.

FIG. 4 is a sectional view of FIG. 3 along line A-A.

FIG. 5 is a perspective partial view of a bottom face of a circuit board, of FIG. 1.

FIG. 6 is a view of an inner side of the position encoder of FIG. 3.

The following implementations are used for the description of the present disclosure in conjunction with above figures.

### DETAILED DESCRIPTION OF THE EMBODIMENTS

Hereinafter technical solutions in embodiments of the present disclosure are described clearly and completely in conjunction with the drawings in embodiments of the present disclosure. Apparently, the described embodiments are only some rather than all of the embodiments of the present disclosure. Any other embodiments obtained based on the embodiments of the present disclosure by those skilled in the art without any creative work fall within the scope of protection of the present disclosure. It is understood that the drawings are only intended to provide reference and illustration, and not to limit the present disclosure. The connections in the drawings are only intended for the clearance of description, and not to limit the type of connections.

It should be noted that, if a component is described to be “connected” to another component, it may be connected to another component directly, or there may be an intervening component simultaneously. All the technical and scientific terms in the present disclosure have the same definitions as the general understanding of those skilled in the art, unless otherwise defined. Herein the terms in the present disclosure are only intended to describe embodiments, and not to limit the present disclosure.

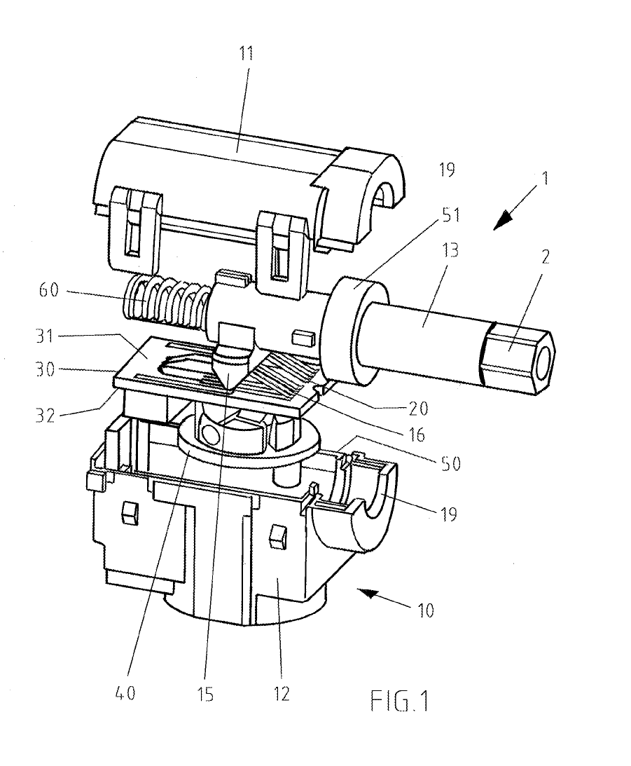

FIG. 1 shows a possible embodiment of an electric switch 1 according to the invention, which may be used for manually operated electric tools and appliances having a motor, for example electric drills, cordless screwdrivers, hammer drills and the like. For this purpose, this switch 1 is incorporated into the housing of the tool and the plunger 13 is connected to, for example, a manually actuation member via a connection 2. An electrical cable (not shown) extends from the electric switch and is connected to the motor. The changeover device 40 is arranged inside the switch housing 10 of the electric switch 1 and is adjustable from the outside via the tappet 46. The changeover device 40 is used for setting the direction of rotation of the motor in an electric tool and interacts with, for example, a corresponding shift lever, which can be adjusted from the outside.

The switch housing 10 of the electric switch shown in FIG. 1 comprises two shells, namely an upper shell 11 and a lower shell 12. A one-piece circumferential seal 50 is provided between the shells 11, 12. And the one-piece circumferential seal 50 comprises a ring 51 in an area of the opening 19. Within the switch housing 10, the plunger 13 is connected to a slider 15, which is movably arranged above the upper face 31 of the circuit board 30. The circuit board 30 is immovably arranged within the housing 10.

The slider 15 is able to perform a linear pushing movement. A pushing movement of the plunger 13 causes, for one thing, a displacement of a sliding contact 16 onto contact surfaces which are designed as potentiometer tracks for regulating rotational speed. The displacement path of the sliding contact 16 changes the resistance connected to the electric switch 1 and therefore the rotational speed or the torque of the motor are changed. Sliding contacts of the contact system 20 are furthermore arranged on the upper face 31 of the circuit board. The sliding contacts influences the corresponding contact surfaces on the upper face 31 of the circuit board 30, thereby switching the contact system, namely from an off position to an on position. The plunger 13 in this embodiment is spring-loaded. A return spring 60 acts to automatically return the plunger 13 to the off position as soon as pressure is no longer being exerted on the plunger 13.

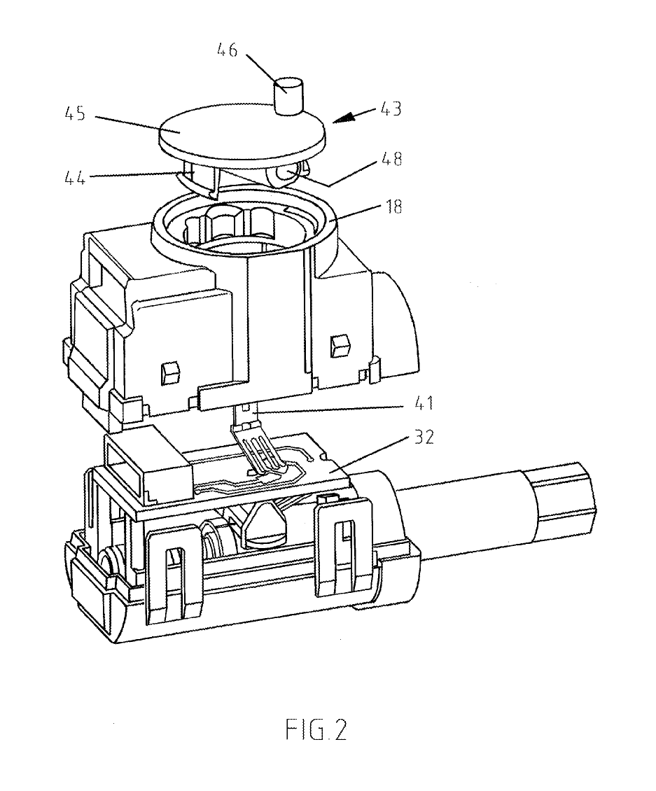

Contact surfaces in the form of conducting paths 35, 36 are likewise provided on the opposite face of the lower face 32 of the circuit board 30 (see FIG. 2). These conducting paths 35, 36 are part of the changeover device and contact the contact tongues 42 of the contact arm 41, meaning that a contact bridge is formed either for the conducting path 35 for counterclockwise rotation of the motor, or, in another position of the contact arm 41, a contact bridge is formed for the conducting path 35 for clockwise rotation of the motor. As is best understood from FIG. 5, located between the conducting paths 35, 36 is an insulating surface 37, which is a so-called neutral position for the changeover device 40. In the neutral position, the contact tongues do not bridge any contacts, and the motor does not rotate. The contact arm 41, upon which the contact tongues 42 are located, is secured directly to the position encoder 43.

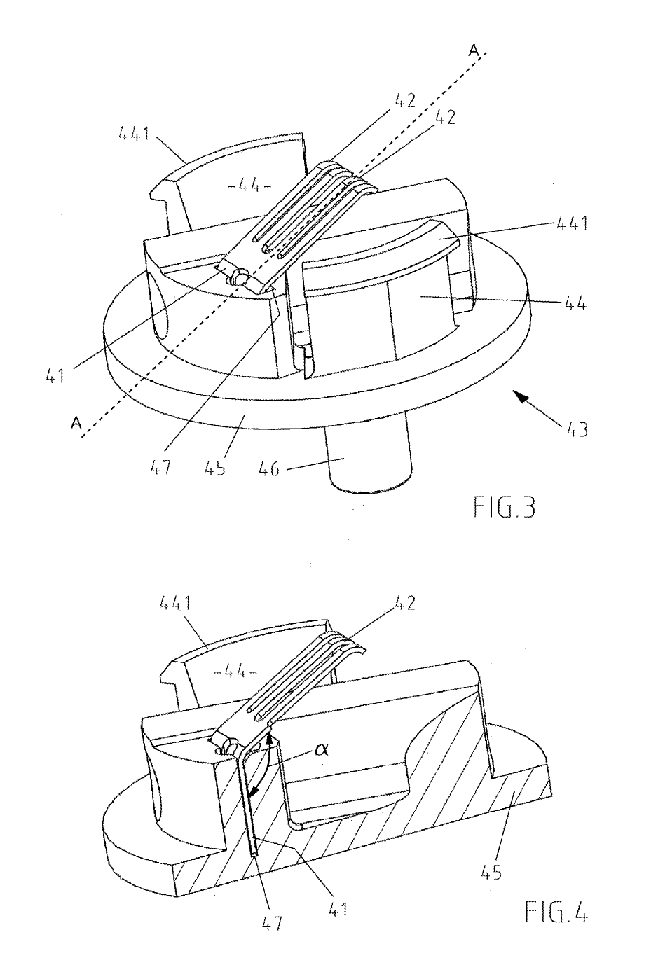

The position encoder 43 is shown in FIG. 3 and, in this example, comprises a disk 45 and the aforementioned tappet 46 which is located outside of the switch housing 10, hence on the outer side of the disk 45. The tappet 46 either protrudes directly from the switching housing 10 of the electric device or, preferably, is connected to a shift lever that is adjustable from the outside. The disk 45 rotates by moving this tappet 46, the direction of rotation of the motor is changed, hence setting clockwise or counterclockwise rotation of the motor. This disk 45 is retained in the switch housing 10, namely in an enclosure 18 of the switch housing 10. Downward protruding edge areas 44 are provided for this purpose on the lower side of the disk 45 of the position encoder 43. Exterior ends of the edge areas are of hook-shaped design on their outer edge 441 so that they hold the position encoder 43 in the enclosure 18 of the switch housing 10 by means of a clamping connection. These edge areas 44 are thus designed to be thin enough for the elasticity required in a clamping connection, yet the disk 45 is designed thick enough that they will securely hold the position encoder 43 in the enclosure 18.

The individual parts of the position encoder 43, namely the disk 45 having the tappet 46, having the edge areas 44, and, in this case, also having stops on the inner side of the disk 45 for mounting a haptic element 48 are made of plastic. As can be gathered from FIG. 3, a hub having a mounting slit 47 for the contact arm 41 is provided on the lower side of the disk 45 of the position encoder 43. As is better shown in the section view of FIG. 4, this contact arm 41 is inserted into the mounting slit 47 by a form fit and/or an interference fit. An orientation of the mounting slit, or rather that of the contact arm 41 inserted into the mounting slit, is perpendicular to an orientation of the circuit board. The contact tongues 42 are bent at an obtuse angle a from the contact arm, and press obliquely against the conducting paths 35, 36. In addition, the ends of the contact tongues 42 are U-shaped so that the spring-loaded contact tongues 42 ensure sufficient contact pressure.

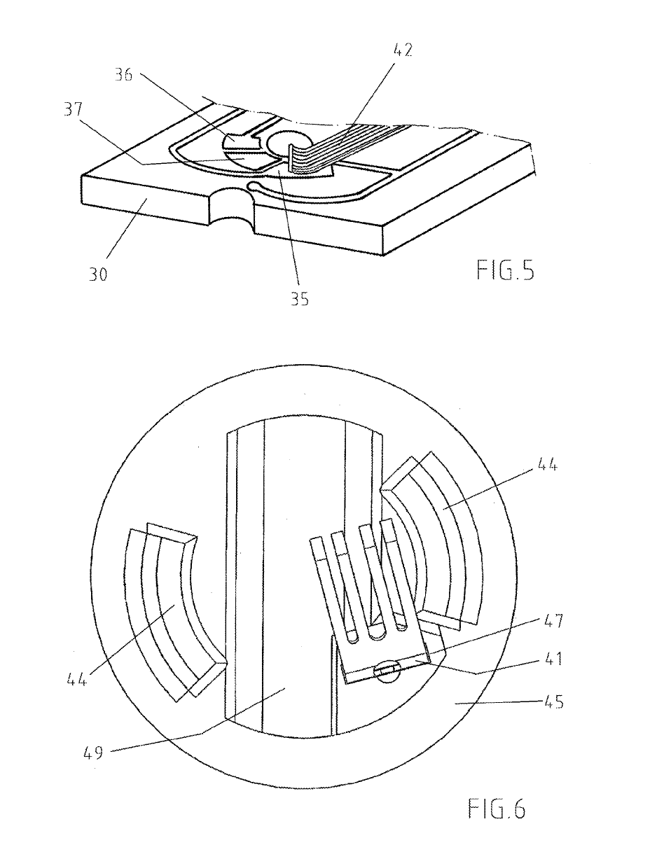

In this case, the mounting slit 47 is arranged on the disk 45 so that rotation of the disk 45 enables the contact arm 41 to move from its present position into a further position. As can be seen from FIG. 6, the mounting slit 47 is provided off-center. Rotation of the disk 45 moves the contact arm 41 into a new rotational position. In the embodiment shown, the two rotational positions, namely those for clockwise rotation of the motor or for counterclockwise rotation of the motor, in which the contact tongues 42 either form a contact bridge to the conducting paths 35 or to the conducting paths 36. Said rotational positions provide haptic feedback to the user by means of a haptic element. Shown in FIG. 2, the haptic element 48 is inserted into a shaped recess 49 on the lower side of the disk 45. The shaped recess is shown in FIG. 6 without the haptic element 48. The haptic element 48 projects from at least one side of the recess 49 and interacts with the peripheral contour of the enclosure 18. Whereby the peripheral contour of the enclosure 18 is designed in particular so that the position encoder 43 engages into only two or, optionally, three rotational positions on the peripheral contour of the enclosure 18 by means of the haptic element 48. These rotational positions thus represent the setting for clockwise rotation, the setting for counterclockwise rotation and, optionally, a neutral position.

Described above are exemplary embodiments of the present disclosure, which are not intended to limit the present disclosure. All the modifications, replacements and improvements in the scope of the concepts and principles of the present disclosure are in the scope of the protection thereof.

1. An electric switch for use in an electric device having a motor, the electric switch comprising:
a switch housing;
a plunger extending from the switch housing and switching from an off position into an on position of at least one contact of a contact system arranged within the switch housing via a movement;
a circuit board;
a changeover device for changing a direction of rotation of the motor; and
wherein the changeover device comprises a position encoder operated from outside, the position encoder is directly connected to a contact arm via two contact tongues; one contact tongue interacts with one conducting path to create a contact for the clockwise rotation of the motor in one position of the position encoder, and/or the other contact tongue interacts with other conducting paths to create a contact for the counterclockwise rotation of the motor in another position of the position encoder.

2. The electric switch of claim 1, wherein contact surfaces of the contact system are arranged on an upper face of the circuit board; and the conducting paths of the changeover device are arranged on a lower face of the circuit board.

3. The electric switch of claim 1, wherein the position encoder comprises a disk, which is arranged parallel to the circuit board and is rotatably retained in an enclosure of the switch housing, wherein a tappet for rotational actuation is provided on an outer side of the disk, an inner side of the disk is connected to the contact arm.

4. The electric switch of claim 3, wherein the disk comprises a mounting slit arranged on the inner side and off center for retaining the contact arm, and an orientation of the mounting slit is perpendicular to the circuit board.

5. The electric switch of claim 3, wherein the disk comprises edge areas radially extending from the inner side, which extend into the enclosure of the switch housing and hold the disk in the enclosure of the switch housing by a clamping connection.

6. The electric switch of claim 5, wherein an engaging connection is provided for retaining the position encoder n the enclosure of the switch housing, the edge areas are elastic, and an outer edge of the edge areas is designed to be hook-shaped.

7. The electric switch of claim 6, wherein the position encoder comprises a haptic element which is arranged on the inner side of the disk and interacts with a corresponding peripheral contour of the enclosure of the switch housing.

8. The electric switch of claim 1, wherein the contact tongues are bent at an obtuse angle (a) from the contact arm, and contact ends of the contact tongues are designed to be U-shaped.

9. The electric switch of claim 1, wherein a device is additionally provided within the switch housing for setting the rotational speed or the torque of the motor.

10. The electric switch of claim 9, wherein the contact surfaces on the upper side of the circuit board are in the form of potentiometer tracks, and the plunger within the switch housing comprises a slider, sliding contacts on the circuit board face the slider so that the rotational speed or the torque of the motor is able to be set by means of interaction between the sliding contacts and the potentiometer tracks of the circuit board.
